(19) United States
(12) Patent Application Publication
(10) Pub. No.: US 2012/0211479 A1
(43) Pub. Date: Aug. 23, 2012

(54) SELF-CLEANING WELDING WIRE CONDUIT

(75) Inventor: Stephen Lloyd Anderson, Traverse City, MI (US)

(73) Assignee: Illinois Tool Works Inc., Glenview, IL (US)

(21) Appl. No.: 13/399,413

(22) Filed: Feb. 17, 2012

Related U.S. Application Data
(60) Provisional application No. 61/444,224, filed on Feb. 18, 2011.

(51) Int. Cl. B23K 9/00

(52) U.S. Cl. 219/136; 219/137.31

(57) ABSTRACT

A welding wire conduit includes an outer tube, a wire spring disposed within the outer tube, and a plurality of cylindrical segments disposed within the wire spring. Each cylindrical segment includes a generally convex first axial end and a generally concave second axial end, and the first axial ends of the cylindrical segments are configured to mate with the second axial ends of the cylindrical segments.

### CROSS-REFERENCE TO RELATED APPLICATIONS

This application claims priority from and the benefit of U.S. Provisional Patent Application No. 61/444,224, filed Feb. 18, 2011, entitled “Self Cleaning Wire Conduit.”

### BACKGROUND

This invention relates to wire feeders for welding guns. More specifically, this invention relates to a welding wire conduit used to transport welding wire from a wire feeder to a welding gun.

The majority of welding machine manufactures around the world use plastic or Teflon tubular liners in their welding wire conduits. Welding wire conduits available today sometimes have the problem of contaminants plugging up the bore of the conduit and ultimately causing the wire to bird nest and stop feeding. This may cause burn back, which often damages the contact tip in the welding gun and causes costly and time-consuming delays in the welding operation. In particular, in the case of aluminum welding wire, these welding wire conduits have a high coefficient of friction between the conduit liner and the aluminum wire, causing feeding problems.

Most welding wire conduits also have a high coefficient of friction between the welding wire and the conduit liner when the conduit is flexed during the welding operation. For the welding wire to travel any significant distance, these welding wire conduits require a push/pull system in order to overcome this high coefficient of sliding friction. In the case of aluminum welding wire, the high force required to push/pull the welding wire through the welding wire conduit causes the welding wire to become deformed. This deformation causes the aluminum wire to deteriorate, generating finely granulated aluminum metal and oxide and aluminum shavings, which plug up the liner of the welding wire conduit and may cause the welding wire feeding to stop, resulting in bird nesting and burn backs of the welding wire.

### BRIEF DESCRIPTION

In one embodiment, a welding wire conduit includes an outer tube, a wire spring disposed within the outer tube, and a plurality of cylindrical segments disposed within the wire spring. Each cylindrical segment includes a generally convex first axial end and a generally concave second axial end, and the first axial ends of the cylindrical segments are configured to mate with the second axial ends of the cylindrical segments.

In another embodiment, a welding system includes a welding torch and a welding wire feeder configured to deliver a welding wire to the welding torch through a welding wire conduit. The welding wire conduit includes an outer tube, a wire spring disposed within the outer tube, and a plurality of ceramic cylindrical segments disposed within the wire spring. Each ceramic cylindrical segment includes a generally convex first axial end and a generally concave second axial end, and the first axial ends of the ceramic cylindrical segments are configured to mate with the second axial ends of the ceramic cylindrical segments.

In another embodiment, a welding wire conduit includes an outer tube, a wire spring disposed within the outer tube, and a plurality of cylindrical segments disposed within the wire spring. Each cylindrical segment includes a generally convex first axial end and a generally concave second axial end, and the first axial ends of the cylindrical segments are configured to mate with the second axial ends of the cylindrical segments. Adjacent cylindrical segments are free to rotate both radially and circumferentially with respect to each other. In addition, a welding wire contact length at a minimum inner diameter of the cylindrical segments is less than approximately 10% of a total axial length of the cylindrical segments.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a welding system in accordance with aspects of the present disclosure;

FIG. 2 is a partial cross-sectional side view of an embodiment of a welding wire conduit in accordance with aspects of the present disclosure;

FIG. 3 is a partial cross-sectional side view of embodiments of a plurality of cylindrical segments of the welding wire conduit of FIG. 2 in accordance with aspects of the present disclosure;

FIG. 4 is a side view of an embodiment of a spring of the welding wire conduit of FIG. 2 in accordance with aspects of the present disclosure;

FIG. 5 is a side view of an embodiment of an outer containment tube of the welding wire conduit of FIG. 2 in accordance with aspects of the present disclosure;

FIG. 6 is a cross-sectional side view of adjacent, abutting cylindrical segments of the welding wire conduit in accordance with aspects of the present disclosure; and

FIGS. 7A and 7B are front and back views of an embodiment of the cylindrical segment of the welding wire conduit taken from first and second axial ends of the cylindrical segment, respectively, in accordance with aspects of the present disclosure.

### DETAILED DESCRIPTION

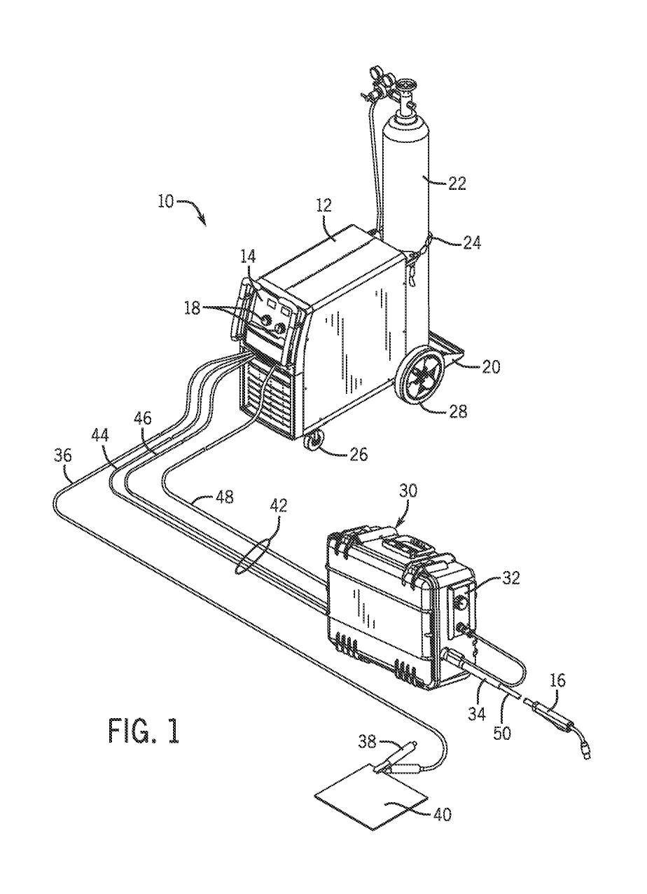

Turning now to the figures, FIG. 1 illustrates an embodiment of a welding system 10 which powers, controls, and provides supplies of welding materials to a welding operation. The welding system 10 includes a welding power supply 12 having a control panel 14 through which a welding operator may control the supply of welding materials, such as gas flow, wire feed, and so forth, to a welding torch 16. To that end, the control panel 14 includes input or interface devices, such as a user interface 18 (e.g., knobs, dials, touch screen, etc.) that the operator may use to adjust welding parameters (e.g., voltage, current, etc.). The welding power supply 12 may also include a tray 20 mounted on a back of the power supply 12 and configured to support a gas cylinder 22 held in place with a securing mechanism 24 (e.g., chain). The gas cylinder 22 is the source of the gas supplied to the welding torch 16. Furthermore, the welding power supply 12 may be portable via a set of smaller front wheels 26 and a set of larger back wheels 28 (or any combination of wheel sizes 26 and 28), which enable the operator to move the power supply 12 to the location of the weld.

The welding system 10 also includes a wire feeder 30 that provides welding wire to the welding torch 16 for use in the welding operation. The wire feeder 30 may include a control panel 32 that allows the user to set one or more wire feed parameters, such as wire feed speed. Additionally, the wire feeder 30 may house a variety of internal components, such as a spool of wire, a spool motor, a motor control assembly, rollers, a roller motor, and so forth. As will be appreciated, the wire feeder 30 may be used with any wire feeding process, such as gas operations (gas metal arc welding (GMAW)) or gasless operations (shielded metal arc welding (SMAW)). For example, the wire feeder may be used in metal inert gas (MIG) welding or tungsten inert gas (TIG) welding.

A variety of cables and conduits couple the components of the welding system 10 together and facilitate the supply of electrical power and welding materials to the welding torch 16. A first cable 34 couples the welding torch 16 to the wire feeder 30. A second cable 36 couples the welding power supply 12 to a work clamp 38 that connects to a workpiece 40 to complete the circuit between the welding power supply 12 and the welding torch 16 during a welding operation. A bundle 42 of cables and conduits couples the welding power supply 12 to the wire feeder 30 and provides weld materials for use in the welding operation. The bundle 42 includes a welding power cable 44, a gas hose 46, and a control cable 48. The control cable 48 may be any suitable type of control cable. It should be noted that the bundle 42 of cables and conduits may not be bundled together in some embodiments.

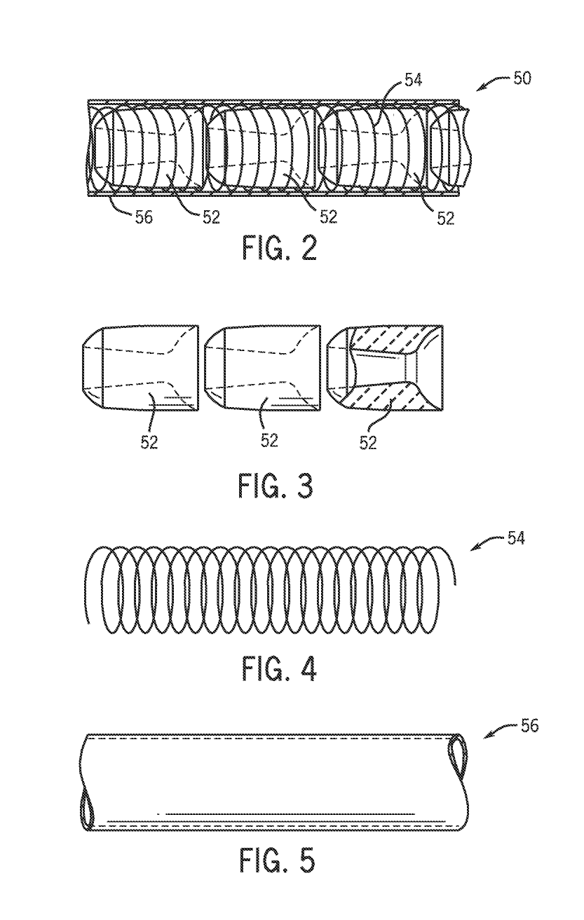

The first cable 34 illustrated in FIG. 1 includes a welding wire conduit 50 for transporting welding wire from the wire feeder 30 to the welding torch 16. FIG. 2 is a partial cross-sectional side view of an embodiment of the welding wire conduit 50 in accordance with aspects of the present disclosure. As illustrated, in certain embodiments, the welding wire conduit 50 includes a plurality of cylindrical segments 52 contained in a loosely wound spring 54, which is in turn contained in an outer containment tube 56. FIGS. 3, 4, and 5 are partial cross-sectional side views and side views of embodiments of the plurality of cylindrical segments 52, spring 54 and outer containment tube 56 of the welding wire conduit 50 of FIG. 2, respectively, in accordance with aspects of the present disclosure.

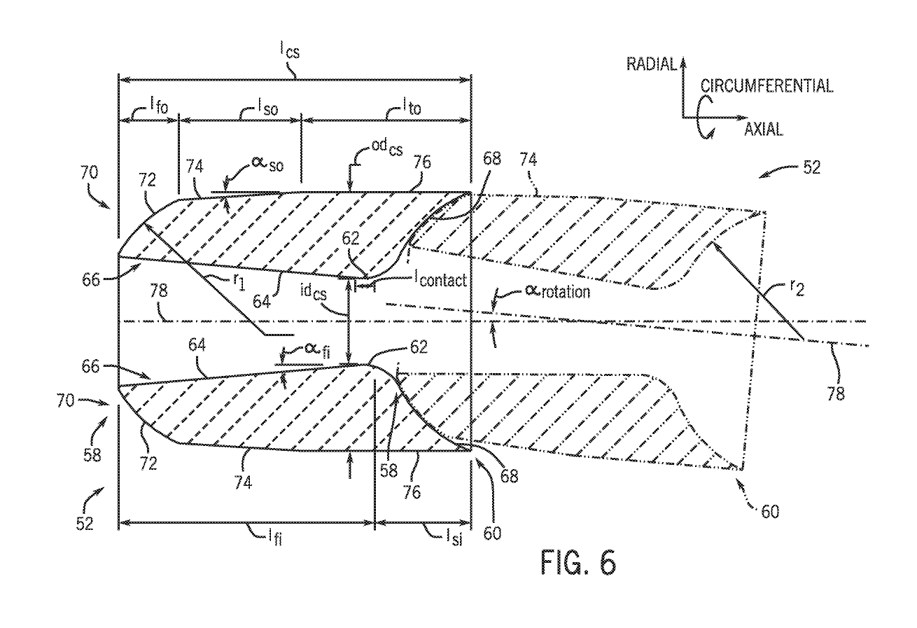

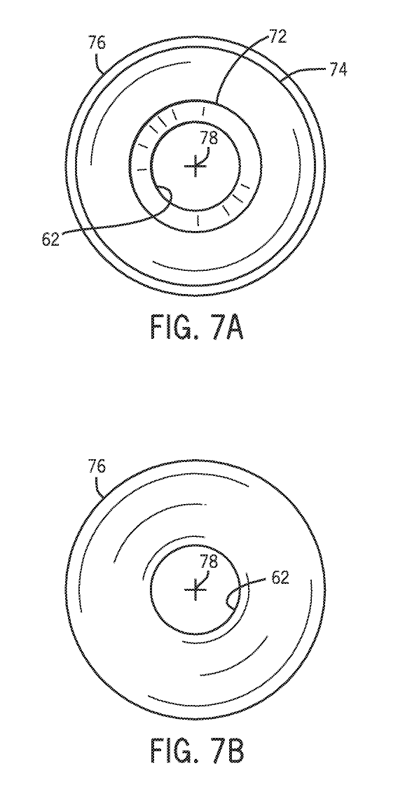

As illustrated in FIGS. 2 and 3, the cylindrical segments 52 each include substantially similar cross-sectional profiles, such that when the cylindrical segments 52 are assembled together within the outer containment tube 56 (and the spring 54), first and second axial ends 58, 60 of abutting cylindrical segments 52 fit together, enabling rotation of adjacent cylindrical segments 52 both radially and circumferentially with respect to each other even though the cylindrical segments 52 are constrained axially within the outer containment tube 56. More specifically, as described in greater detail below with respect to FIGS. 6 and 7, the first axial ends 58 of the cylindrical segments 52 include a substantially convex shape, whereas the second axial ends 60 of the cylindrical segments 52 include a substantially concave shape. The cylindrically convex first axial ends 58 of the cylindrical segments 52 mate with the cylindrically concave second axial ends 60 of the cylindrical segments 52, and the mating convex and concave shapes enable adjacent, abutting cylindrical segments 52 to rotate circumferentially with respect to each other, as well radially (i.e., perpendicular to an axial centerline of the cylindrical segments 52) with respect to each other. However, when assembled within the outer containment tube 56, the cylindrical segments 52 remain axially constrained with respect to each other.

In certain embodiments, the cylindrical segments 52 may be made of ceramic, glass, metal, or plastic. For example, the cylindrical segments 52 may be made of a fused ceramic material. In certain embodiments, the spring 54 may be a wire spring made from any number of metals, but will probably be most cost effective if produced from carbon steel or stainless steel, depending on the degree of the corrosive atmosphere to which it is subjected. In general, the spring 54 is configured to flex with the cylindrical segments 52 when the outer containment tube 56 is flexed by the user. In certain embodiments, the outer containment tube 56 may be made of any number of relatively flexible materials such as plastic, rubber, carbon fiber, glass fiber, fabric, or certain metals. For example, plastic tubing may be used for the outer containment tube 56 due to its relatively low cost and electrical insulating properties.

FIG. 6 is a cross-sectional side view of adjacent, abutting cylindrical segments 52 of the welding wire conduit 50 in accordance with aspects of the present disclosure. More specifically, FIG. 6 depicts how the convex first axial end 58 of one cylindrical segment 52 mates with the concave second axial end 60 of an adjacent cylindrical segment 52. In particular, the radii of curvature r₁ of the first axial ends 58 of the cylindrical segments 52 may be substantially similar to the radii of curvature r₂ of the second axial ends 60 of the cylindrical segments 52. For example, in certain embodiments, the radii of curvature r₁, r₂ may be within approximately 5%, 4%, 3%, 2%, 1%, or even closer, of each other. Furthermore, in certain embodiments, the ratio of the axial length l_{cs} of the cylindrical segments 52 to the radii of curvature r₁, r₂ of the cylindrical segments 52 may be within a range of approximately 1.5 to approximately 3.0. For example, in certain embodiments, the axial length l_{cs} of the cylindrical segments 52 may be within a range of approximately 0.25 inch and approximately 0.75 inch and, more specifically, may be approximately 0.25 inch, 0.3125 inch, 0.375 inch, 0.4375 inch, 0.5 inch, 0.5625 inch, 0.625 inch, 0.6875 inch, 0.75 inch, or any other comparable length. In addition, in certain embodiments, the radii of curvature r₁, r₂ of the first and second axial ends 58, 60 of the cylindrical segments 52 may be within a range of approximately 0.125 inch to approximately 0.375 inch and, more specifically, may be approximately 0.125 inch, 0.15625 inch, 0.1875 inch, 0.21875 inch, 0.25 inch, 0.28125 inch, 0.3125 inch, 0.34375 inch, 0.375 inch, or any other comparable radius. As will be appreciated, the dimensions presented herein are merely exemplary in order to show the relative magnitude of the dimensions of the cylindrical segments 52, and are not intended to be limiting. Other dimensions may be used.

As illustrated in FIG. 6, the cylindrical segments 52 may be designed to freely rotate radially with respect to each other up to a maximum angle α_{max,} wherein the maximum angle αₘₐₓ of radial rotation is determined such that the welding wire being delivered through the cylindrical segments 52 is not pinched (e.g., constricted) at minimum diameter points 62 of one cylindrical segment 52 (e.g., the left cylindrical segment 52 illustrated in FIG. 6) by the first axial end 58 of the adjacent (i.e., “downstream”) cylindrical segment 52 (e.g., the right cylindrical segment 52 illustrated in FIG. 6). In other words, the limiting inner diameter (e.g., at points 62) of the cylindrical segments 52 may be selected to allow for maximum angular clearance (i.e., maximum possible angle αₘₐₓ) for bending of the welding wire conduit 50 while also providing minimum sliding friction.

For example, in certain embodiments, an angle α_{fi} of a first inner wall section 64 of an inner wall 66 of the cylindrical segments 52 and/or a length l_{fi} of the first inner wall section 64 of the inner wall 66 of the cylindrical segments 52 and/or a length lₛᵢ of a second inner wall section 68 of the inner wall 66 of the cylindrical segments 52 may be adjusted such that the angle and degree of taper of the first and second inner wall sections 64, 68 of the inner wall 66 provide for a desired degree of bending freedom of the welding wire conduit 50. Similarly, the maximum angle αₘₐₓ of bending may also be adjusted by shortening the axial length l_{cs} of the cylindrical segments 52 while maintaining the diameter dimensions (e.g., an inner diameter id_{cs} of the cylindrical segments 52), or increasing the diameter dimensions for a given axial length l_{cs}.

Furthermore, a length l_{contact} at the points 62 that correspond to the minimum inner diameter id_{cs} of the cylindrical segments 52 is relatively small compared to the total axial length l_{cs} of the cylindrical segments 52. This welding wire contact length l_{contact} may be defined as the length at the points 62 of the inner wall 66 that is substantially parallel (e.g., within approximately 5 degrees) to a central axis 78 of the cylindrical segments 52. As such, this welding wire contact length l_{contact} is the length of the inner wall 66 that is expected to contact the welding wire as the welding wire is transmitted through the cylindrical segment 52. In certain embodiments, the welding wire contact length l_{contact} of the cylindrical segments 52 may be less than approximately 10% of the total length of the l_{cs} of the cylindrical segments 52 and, more specifically, may be less than approximately 10%, 9%, 8%, 7%, 6%, 5%, or even less of the total axial length l_{cs} of the cylindrical segments 52, depending on the particular dimensions of the cylindrical segments 52.

In certain embodiments, the length l_{fi} of the first inner wall section 64 of the inner wall 66 of the cylindrical segments 52 may be in a range of approximately 60-80% of the total axial length l_{cs} of the cylindrical segments 52 and, more specifically, may be approximately 60%, 65%, 70%, 75%, 80%, or any other comparable percentage of the total axial length l_{cs} of the cylindrical segments 52. In addition, in certain embodiments, the angle α_{fi} of the first inner wall section 64 of the inner wall 66 of the cylindrical segments 52 may be in a range of approximately 3 degrees to approximately 7 degrees and, more specifically, may be approximately 3.0 degrees, 3.5 degrees, 4.0 degrees, 4.5 degrees, 5.0 degrees, 5.5 degrees, 6.0 degrees, 6.5 degrees, 7.0 degrees, or any other comparable angle.

As such, in certain embodiments, a ratio of the minimum inner diameter id_{cs} of the cylindrical segments 52 to a maximum outer diameter od_{cs} of the cylindrical segments 52 may be within a range of approximately 20-40% and, more specifically, may be approximately 20%, 25%, 30%, 35%, 40%, or any other comparable percentage. For example, in certain embodiments, the maximum outer diameter od_{cs} of the cylindrical segments 52 may be within a range of approximately 0.25 inch and approximately 0.5 inch and, more specifically, may be approximately 0.25 inch, 0.3125 inch, 0.375 inch, 0.4375 inch, 0.5 inch, or any other comparable diameter. In addition, in certain embodiments, the minimum inner diameter id_{cs} of the cylindrical segments 52 may be within a range of approximately 0.0625 inch and approximately 0.1875 inch and, more specifically, may be approximately 0.0625 inch, 0.09375 inch, 0.125 inch, 0.15625 inch, 0.1875 inch, or any other comparable diameter. Again, these dimensions are merely exemplary in order to show the relative magnitude of the dimensions of the cylindrical segments 52, and are not intended to be limiting. Other dimensions may be used. In certain embodiments, these diameters are selected based on the diameter of the welding wire being used.

In certain embodiments, the resulting maximum angle αₘₐₓ of radial rotation with respect to adjacent cylindrical segments 52 may be up to approximately 5 degrees (or perhaps more), depending on the specific dimensions of the cylindrical segments 52. As such, the spring 54 and the outer containment tube 56 may be selected to have similar maximum angles of deflection along any points of the spring 54 and the outer containment tube 56.

An outer wall 70 of the cylindrical segments 52 may also have features that facilitate the radial rotation of adjacent cylindrical segments 52. More specifically, in certain embodiments, the outer wall 70 of the cylindrical segments 52 may include first, second, and third outer wall sections 72, 74, 76 from the first axial end 58 of the cylindrical segments 52 to the second axial end 60 of the cylindrical segments 52. As illustrated, the first outer wall section 72 of the cylindrical segments 52 is a cylindrically outwardly rounded (i.e., convex) portion that mates with a cylindrically inwardly rounded (e.g., concave) portion of the second inner wall section 68 of the inner wall 66 of the cylindrical segments 52.

In addition, in certain embodiments, an intermediate second outer wall section 74 may extend from the first outer wall section 72 to the third outer wall section 76, which is substantially parallel with (e.g., concentric to) the central axis 78 of the cylindrical segment 52. The second outer wall section 74 may be acutely angled away from (as opposed to the first inner wall section 64, which is acutely angled toward) the centerline 78 at the second axial end 60 of the cylindrical segment 52 by an angle αₛₒ. As illustrated by the cylindrical segment 52 on the right in FIG. 6, the angle αₛₒ of the second outer wall section 74 may be selected such that a portion of the third outer wall section 76 of one (e.g., upstream) cylindrical segment 52 is substantially parallel with (e.g., within approximately 5 degrees), and abuts, a portion of the second outer wall section 74 of an adjacent (e.g., downstream) cylindrical segment 52 when the two cylindrical segments 52 are at the maximum angle αₘₐₓ of radial rotation (e.g., maximum flexing) with respect to each other. In certain embodiments, this maximum angle αₘₐₓ of radial rotation of the cylindrical segments 52 may be selected based on the maximum possible flexing of the outer containment tube 56 (as well as the spring 54).

In certain embodiments, the angle αₛₒ of the second outer wall section 74 of the outer wall 70 of the cylindrical segments 52 may be in a range of approximately 2 degrees to approximately 6 degrees and, more specifically, may be approximately 2.0 degrees, 2.5 degrees, 3.0 degrees, 3.5 degrees, 4.0 degrees, 4.5 degrees, 5.0 degrees, 5.5 degrees, 6.0 degrees, or any other comparable angle. In addition, in certain embodiments, an axial length l_{fo} of the first outer wall section 72 of the outer wall 70 of the cylindrical segments 52 may be in a range of approximately 10-20% of the total axial length l_{cs} of the cylindrical segments 52 and, more specifically, may be approximately 10%, 12%, 14%, 16%, 18%, 20%, or any other comparable percentage of the total axial length l_{cs} of the cylindrical segments 52. In addition, in certain embodiments, an axial length lₛₒ of the second outer wall section 74 of the outer wall 70 of the cylindrical segments 52 may be in a range of approximately 25-45% of the total axial length l_{cs} of the cylindrical segments 52 and, more specifically, may be approximately 25%, 30%, 35%, 40%, 45%, or any other comparable percentage of the total axial length l_{cs} of the cylindrical segments 52. In addition, in certain embodiments, an axial length lₜₒ of the third outer wall section 76 of the outer wall 70 of the cylindrical segments 52 may be in a range of approximately 40-60% of the total axial length l_{cs} of the cylindrical segments 52 and, more specifically, may be approximately 40%, 45%, 50%, 55%, 60%, or any other comparable percentage of the total axial length l_{cs} of the cylindrical segments 52. Again, these dimensions are merely exemplary in order to show the relative magnitude of the dimensions of the cylindrical segments 52, and are not intended to be limiting. Other dimensions may be used.

FIGS. 7A and 7B are front and back views of an embodiment of the cylindrical segment 52 of the welding wire conduit 50 taken from the first and second axial ends 58, 60, respectively, in accordance with aspects of the present disclosure. As illustrated in FIG. 7A, the three outer rings are the points at which the first, second, and third outer wall sections 72, 74, 76 of the outer wall 70 begin (from the perspective of the first axial end 58 of the cylindrical segment 52), and the inner ring is the minimum inner diameter id_{cs} of the cylindrical segment 52, which occurs at the points 62 illustrated in FIG. 6. From the perspective of the second axial end 60 (FIG. 7B), the outer ring is the maximum outer diameter od_{cs} of the cylindrical segment 52, which occurs at the third outer wall section 76 of the outer wall 70, and the inner ring is the minimum inner diameter id_{cs} of the cylindrical segment 52, which occurs at the points 62 illustrated in FIG. 6.

The welding wire conduit 50 described herein reduces sliding friction between the welding wire delivered through the welding wire conduit 50 and the conduit liner (e.g., the outer containment tube 56). In addition, the welding wire conduit 50 provides a self-cleaning feature that prevents buildup of contaminants in the conduit bore, and that may be easily cleaned and returned to service. For example, the cylindrical segments 52 include a hole (e.g., the inner wall 66) that is sized appropriately for the welding wire to be delivered therethrough. The inner wall 66 is bell mouthed on each end. In other words, both the first and second inner wall sections 64, 68 converge at the smallest diameter points 62 such that the cylindrical segments 52 provide clearance for the welding wire to pass through the cylindrical segments 52 even when adjacent cylindrical segments 52 rotate radially with respect to each other when the welding wire conduit 50 is flexed (e.g., when the welding torch 16 is moved about to conduct a desired weld). The narrow land of the minimum inner diameter id_{cs} (e.g., at points 62) of each cylindrical segment 52 has the added advantage of limiting the contact area between the welding wire so as to reduce sliding friction as the welding wire is transmitted through the welding wire conduit 50 from the wire feeder 30 to the welding torch 16.

In the interest of providing a low coefficient of friction combined with long service life, the cylindrical segments 52 may be made of fused ceramic material when the welding wire to be used is aluminum welding wire. The cylindrical segments 52 described herein provide at least four main functions. First, the cylindrical segments 52 are capable of both rotational and axial flexing relative to each other (e.g., rotation circumferentially with respect to each other, and rotation perpendicular to the central axis 78) such that the welding wire conduit 50 may be bent and twisted while conducting welding operations. To accomplish this, the cylindrical segments 52 have a ball and socket type design, which allows for unlimited rotary and axial motion when a number of cylindrical segments 52 are assembled end-to-end coaxially within the outer containment tube 56 (and the spring 54).

Second, the geometric design of the cylindrical segments 52 include an internal passageway that provides for angular clearance when the welding wire conduit 50 is bent such that the cylindrical segments 52 maintain the cylindricity of the internal passageway, and the diametrical clearance between the welding wire and the internal passageway is maintained. The allowable angle of bending (i.e., the maximum rotational angle αₘₐₓ described above) that may be tolerated may be adjusted by altering the angles and lengths, among other parameters, of the entry and exit passageways (e.g., the first and second inner wall sections 64, 68), as described above.

Third, the arrangement of the shape of the angular sections of each cylindrical segment 52 provides for the movement of contaminants to collection sites that do not interfere with the linear motion of the welding wire through the cylindrical segments 52. The cylindrical segments 52 include a very short axial distance (i.e., l_{contact}) where the controlling diameter (e.g., the minimum inner diameter id_{cs} at points 62) of the welding wire conduit 50 is maintained. In certain embodiments, for example, the cylindrical segments 52 may be designed such that this controlling diameter is not larger than twice the diameter of aluminum wire being used. The aluminum fines and shavings typically found in MIG welding systems using aluminum wire tend to plug conventional welding wire conduits over time as the system feeds aluminum wire through the welding wire conduit. This plugging phenomenon is generally a function of the distance the wire travels through the welding wire conduit at a constant specified diametrical clearance.

In contrast, the cylindrical segments 52 described herein have the controlling diameter (e.g., the minimum inner diameter id_{cs} at points 62) for only a very short axial distance l_{contact} (e.g., approximately 5-10%, or even less, of the total length l_{cs} of the cylindrical segments 52). The vast majority of the inner wall 66 of the cylindrical segments 52 has a much larger diameter. This provides for the movement of fines and shavings past the controlling diameter constriction point (e.g., points 62) and into the large cavity that exists at the exit end of each cylindrical segment 52. Fines and shavings entering this cavity fall off the welding wire and are accumulated, where they may exit the column of cylindrical segments 52 and enter the area around the loosely wound spring 64 and the outer containment tube 56 holding the assembly of the welding wire conduit 50 together. More specifically, the cylindrical segments 52 are held loosely together by the spring 54, and thus back-and-forth motion of adjacent cylindrical segments 52 will gradually suck the fines and shavings through the area between the adjacent cylindrical segments 52, thus preventing the bore of the welding wire conduit 50 from building up with contaminants that might otherwise eventually stop the welding wire from feeding through the welding wire conduit 50. Once the fines and shavings are in the area between the cylindrical segments 52 and the outer containment tube 56, they may be easily cleaned out on a periodic basis. For example, the spring 54 may be easily removed from the outer containment tube 56 in order to clean the welding wire conduit 50. After removal from the outer containment tube 56, the spring 54 may be tapped, flexed, or otherwise manipulated to allow the accumulated contaminants to be blown out or simply allowed to fall out of the spring 54. After cleaning, the spring 54 and the cylindrical segments 52 may then simply be re-inserted into the outer containment tube 56.

Fourth, the cylindrical segments 52 reduce or even eliminate a substantial amount of sliding friction by keeping the controlling diameter (e.g., the minimum inner diameter id_{cs} at points 62) as short as possible. This is desirable for all welding wire materials, but is particularly desirable for aluminum welding wire, which is typically the most difficult type of welding wire to feed through a welding wire conduit.

As described above, the dimensions of the welding wire conduit 50 (and, more specifically, the cylindrical segments 52) that are presented herein are merely exemplary, and not intended to be limiting. In particular, the diameters and lengths of the cylindrical segments 52 may be varied based on, among other things, the type of welding application and welding wire that is intended to be used with the particular welding wire conduit 50. For example, the diametrical clearance between the bores (e.g., the minimum inner diameter id_{cs} at the points 62) may vary as the particular welding application requires. In general, larger diametrical clearances may be possible when compared to those used with conventional welding wire conduits due at least in part to the reduced sliding friction that is possible using the cylindrical segments 52 and the types of cylinder materials presented herein. The types of materials that the cylindrical segments 52 may be made from are virtually unlimited. Again, the types of materials that may prove particularly beneficial are vitrified ceramics, which provide a high degree of wear resistance for relatively low costs.

The embodiments described herein also reduce the incidence of welding wire bird nesting and burn backs, thus providing the user with a substantial reduction in operational down time in their welding operations. Moreover, less force is required to feed the welding wire through the welding wire conduit 50. In the case of aluminum welding wire, this reduces the distortion of the welding wire by feed rolls, guides, and the welding wire conduit 50. This results in the generation of less fines of aluminum metal and aluminum oxide and aluminum shavings, which would otherwise plug the welding wire conduit 50. This results in less wire feeding stoppage and lost welding production time. Moreover, due to less wire distortion in the wire feeder 30, the welding torch 16 is able to keep the cast and pitch of the welding wire more constant, providing for a more accurate placement of the welding wire during welding operations. This advantage is particularly useful in robotic welding operations, where precise seam tracking is an important consideration.

The welding wire conduit 50 is also easy to clean and maintain, thus providing an extremely long life of the welding wire conduit 50. For example, the self-cleaning nature of the welding wire conduit 50 lengthens the time between required cleaning operations by a factor of 10 or more. This also results in less downtime in the welding operations. Moreover, the ability to easily and quickly clean and return the welding wire conduit 50 to production lengthens the life of the welding wire conduit 50 as compared to conventional welding wire conduits by a factor of 20-50 times, or even more. As such, the embodiments described herein provide significant cost savings in welding operations. In addition, the individual cylindrical segments 52, the spring 54, and the outer containment tube 56 are all replaceable, and may be easily substituted based on the particular welding operations. As such, all of the individual components of the welding wire conduit 50 may be replaced, as needed, such that the welding wire conduit 50 remains in excellent condition throughout its life.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding wire conduit, comprising:
an outer tube;
a wire spring disposed within the outer tube; and
a plurality of cylindrical segments disposed within the wire spring, wherein each cylindrical segment comprises a generally convex first axial end and a generally concave second axial end, wherein the first axial ends of the cylindrical segments are configured to mate with the second axial ends of the cylindrical segments.

2. The welding wire conduit of claim 1, wherein adjacent cylindrical segments are free to rotate both radially and circumferentially with respect to each other.

3. The welding wire conduit of claim 1, wherein a welding wire contact length at a minimum inner diameter of the cylindrical segments is less than approximately 10% of a total axial length of the cylindrical segments.

4. The welding wire conduit of claim 1, wherein each cylindrical segment comprises an inner wall having first and second inner wall sections extending from the first axial end to the second axial end, wherein the first inner wall section is acutely angled toward the second axial end with respect to a central axis of the cylindrical segment, and the second inner wall section is inwardly rounded into the inner wall.

5. The welding wire conduit of claim 4, wherein each cylindrical segment comprises an outer wall having first, second, and third outer wall sections extending from the first axial end to the second axial end, wherein the first outer wall section is outwardly rounded from the outer wall, the second outer wall section is acutely angled away from the second axial end with respect to a central axis of the cylindrical segment, and the third outer wall section is substantially parallel to the central axis of the cylindrical segment.

6. The welding wire conduit of claim 5, wherein a portion of the third outer wall section of a first cylindrical segment of the plurality of cylindrical segments is substantially parallel with a portion of the second outer wall section of a second adjacent cylindrical segment of the plurality of cylindrical segments when the first and second cylindrical segments are rotated radially with respect to each other at a maximum flexing angle of the outer tube.

7. The welding wire conduit of claim 6, wherein a minimum inner diameter of the first cylindrical segment is not constricted by the first axial end of the second cylindrical segment when the first and second cylindrical segments are rotated radially with respect to each other at the maximum flexing angle of the outer tube.

8. The welding wire conduit of claim 5, wherein a first radius of curvature of the first outer wall section and a second radius of curvature of the second inner wall section are substantially equivalent.

9. The welding wire conduit of claim 1, wherein each cylindrical segment comprises a fused ceramic material.

10. The welding wire conduit of claim 1, wherein the outer tube comprises a relatively flexible material capable of flexing up to approximately 5 degrees at any given point along a length of the outer tube.

11. A welding system, comprising:
a welding torch; and
a welding wire feeder configured to deliver a welding wire to the welding torch through a welding wire conduit, wherein the welding wire conduit comprises an outer tube, a wire spring disposed within the outer tube, and a plurality of ceramic cylindrical segments disposed within the wire spring, wherein each ceramic cylindrical segment comprises a generally convex first axial end and a generally concave second axial end, wherein the first axial ends of the ceramic cylindrical segments are configured to mate with the second axial ends of the ceramic cylindrical segments.

12. The welding system of claim 11, wherein adjacent ceramic cylindrical segments are free to rotate both radially and circumferentially with respect to each other.

13. The welding system of claim 11, wherein a welding wire contact length at a minimum inner diameter of the ceramic cylindrical segments is less than approximately 10% of a total axial length of the ceramic cylindrical segments.

14. The welding system of claim 11, wherein each ceramic cylindrical segment comprises an inner wall having first and second inner wall sections extending from the first axial end to the second axial end, wherein the first inner wall section is acutely angled toward the second axial end with respect to a central axis of the ceramic cylindrical segment, and the second inner wall section is inwardly rounded into the inner wall.

15. The welding system of claim 14, wherein each ceramic cylindrical segment comprises an outer wall having first, second, and third outer wall sections extending from the first axial end to the second axial end, wherein the first outer wall section is outwardly rounded from the outer wall, the second outer wall section is acutely angled away from the second axial end with respect to a central axis of the ceramic cylindrical segment, and the third outer wall section is substantially parallel to the central axis of the ceramic cylindrical segment.

16. The welding system of claim 15, wherein a portion of the third outer wall section of a first ceramic cylindrical segment of the plurality of ceramic cylindrical segments is substantially parallel with a portion of the second outer wall section of a second adjacent ceramic cylindrical segment of the plurality of ceramic cylindrical segments when the first and second ceramic cylindrical segments are rotated radially with respect to each other at a maximum flexing angle of the outer tube.

17. The welding system of claim 16, wherein a minimum inner diameter of the first ceramic cylindrical segment is not constricted by the first axial end of the second ceramic cylindrical segment when the first and second ceramic cylindrical segments are rotated radially with respect to each other at the maximum flexing angle of the outer tube.

18. The welding system of claim 15, wherein a first radius of curvature of the first outer wall section and a second radius of curvature of the second inner wall section are substantially equivalent.

19. The welding system of claim 11, wherein the outer tube comprises a relatively flexible material capable of flexing up to approximately 5 degrees or more at any given point along a length of the outer tube.

20. A welding wire conduit, comprising:
an outer tube;
a wire spring disposed within the outer tube; and
a plurality of cylindrical segments disposed within the wire spring, wherein each cylindrical segment comprises a generally convex first axial end and a generally concave second axial end, wherein the first axial ends of the cylindrical segments are configured to mate with the second axial ends of the cylindrical segments, wherein adjacent cylindrical segments are free to rotate both radially and circumferentially with respect to each other, wherein a welding wire contact length at a minimum inner diameter of the cylindrical segments is less than approximately 10% of a total axial length of the cylindrical segments.
